(19) United States
(12) Patent Application Publication
(10) Pub. No.: US 2015/0302329 A1
(43) Pub. Date: Oct. 22, 2015

(54) FLEXIBLE INSTALLER TAGGING

(71) Applicant: Tightrope Interactive, Inc., San Francisco, CA (US)

(72) Inventors: Franco Yuvienco, New York, NY (US); John Nguyen, San Francisco, CA (US)

(73) Assignee: Tightrope Interactive, Inc., San Francisco, CA (US)

(21) Appl. No.: 14/687,796

(22) Filed: Apr. 15, 2015

Related U.S. Application Data
(60) Provisional application No. 61/980,516, filed on Apr. 16, 2014.

(51) Int. Cl. G06Q 10/06; G06F 9/445

(52) U.S. Cl. CPC G06Q 10/0639; G06F 8/60

(57) ABSTRACT

Systems and methods for flexible installer tagging in a product bundle. Mutable tags are injected into a product bundle. The product bundle is deployed and it is determined whether the mutable tag should change to a new value. If it is determined that the mutable tag should change to a new value, a clone of the product bundle is generated. A modified product bundle is created by modifying the mutable tag in the clone of the product bundle to have the new value.

### CROSS REFERENCE TO RELATED APPLICATIONS

This application is related to U.S. patent application Ser. No. 13/935.266, filed Jul. 3, 2013, entitled “Dynamic Product Bundling,” which is incorporated herein by reference. Further, this application claims priority to U.S. Provisional Application No. 61/980,516, filed Apr. 16, 2014, entitled “FLEXIBLE INSTALLER TAGGING,” which is incorporated herein by reference.

### BACKGROUND

An area of ongoing research and development is the bundling of products together. Bundling of products is particularly important to software. Specifically, many types of software programs are designed to function with other types of software programs. Furthermore, as software can be easily purchased and used by being downloaded from or accessed through a network, offering a number of software programs together through a bundled product can increase revenue as a user might be more inclined to download or purchase related software that is presented to them after downloading a specific software program.

As a result, software product bundles have been created that include software products and advertised software products. Entities have been developed to create software product bundles and offer the software product bundles for other software developers or publishers. The advertised software products can be offered through either free access or free trial access. There are however limitations of current software product bundling services. Specifically, problems arise in performing analytics regarding product bundle performance. Typically, cookies are used to track user behavior in interacting with product bundles. This is problematic as often times different web browsers are used to interact with product bundles leading to error in tracking user interaction with a product bundle used in performing analytics regarding product bundle performance. There therefore, exists a need for improved systems and methods for tracking user interactions with product bundles.

Other limitations of the relevant art will become apparent to those of skill in the art upon a reading of the specification and a study of the drawings.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

Various implementations include systems and methods for tracking product bundles. A mutable tag is injected into a product bundle that associates the product bundle with a parameter. During the life of the product bundle, including when a user begins interacting with the product bundle, it is determined whether the mutable tag should change to a new value to associate a new parameter with the product bundle. If it is determined that the mutable tag should be changed to the new value, generating a clone of the product bundle. The clone of the product bundle is modified to generate a modified product bundle by changing the mutable tag in the clone of the product bundle to the new value. The modified product bundle is then deployed where a user can interact with or further interact with the modified product bundle.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for creating product bundles with injected tags and performing analytics for the product bundles using the injected tags.

FIG. 2 depicts a diagram of an example of a system for generating and controlling mutable and immutable tags in a product bundle.

FIG. 3 depicts a diagram of an example of a system for injecting tags into a product bundle.

FIG. 4 depicts a diagram of an example of a system for generating tags.

FIG. 5 depicts a diagram of an example of a system for performing bundle analytics on bundles with injected tags.

FIG. 6 depicts a flowchart of an example of a method for controlling tags injected into a product bundle.

FIG. 7 depicts a flowchart of an example of a method for injecting tags into products in a product bundle.

FIG. 8 depicts a flowchart of an example of a method for generating an analytics report from bundle performance data that includes tags.

### DETAILED DESCRIPTION

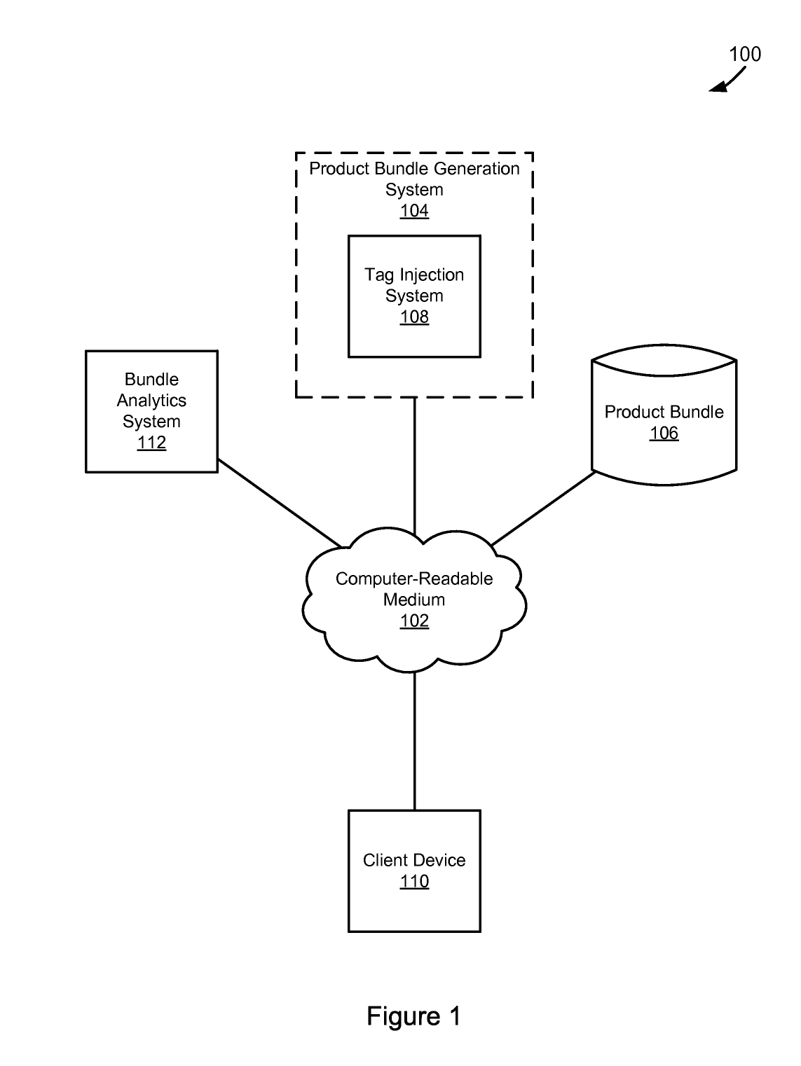

FIG. 1 depicts a diagram 100 of an example of a system for creating product bundles with injected tags and performing analytics for the product bundles using the injected tags. The system of the example of FIG. 1 includes a computer-readable medium 102, a product bundle generation system 104, a product bundle datastore 106, a client device 110, and a bundle analytics system 112.

The product bundle generation system 104, the product bundle datastore 106, the client device 110, and the bundle analytics system 112 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102, the product bundle generation system 104, the client device 110, the bundle analytics system 112, and other systems, or devices described in this paper can be implemented as a computer system or parts of a computer system or a plurality of computer systems. A computer system, as used in this paper, can include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine or through multiple engines. As used in this paper, an engine includes at least two components: 1) a dedicated or shared processor and 2) hardware, firmware, and/or software modules that are executed by the processor. Depending upon implementation-specific or other considerations, an engine can be centralized or its functionality distributed. An engine can be a specific purpose engine that includes specific purpose hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

In a specific implementation, the product bundle generation system 104 functions to generate product bundles; the product bundles generated by the product bundle generation system 104 include products. A product can include an application program having a set of executable files and a set of associated files. As an example, the product can be a word processing application. Alternatively, a product can include a datastore associated with or parsed by a specific application program. As an example, the product can be a “.pdf” data file.

In a specific implementation, the product bundles generated by the product bundle generation system 104 include primary products. A primary product can include an application program or data file that is popular to users. The popularity of the application program or data file can be based, for example, on the number of users that have requested to download the product, the number of users expected to download the product, or some other applicable metric for determining the popularity of a product. A bundle that contains the primary product or a link to download or use the primary product can be pushed to the client when a user requests the primary product contained within the product bundle, after the user requests the primary product, or at some other applicable time. Depending upon implementation-specific, configuration-specific, or other considerations, the primary product can be implemented as a free product, e.g. an open source product; a trial version of a paid-for product that can be interacted with or used for a certain amount of time or under certain limited conditions without a user first paying for the right to use the product, e.g. a “freemium” product; a paid-for product that requires payment before the user can use the product; or some other applicable model.

In a specific implementation, the product bundles generated by the product bundle generation system 104 include advertised products. Advertised products can include products not explicitly requested by a user but included as part of the bundle. For example, if a user requests a word processing application as a primary product, then an advertised product that is included as part of the product bundle created in response to the request can be additional fonts that are compatible for use with the requested word processing application.

In a specific implementation, the product bundle generation system 104 generates dynamic product bundles. A dynamic product bundle includes at least a first product that can be displayed to a user and a second product that is displayed to the user as the product bundle is prepared for or transmitted to a user or as a user interacts with the product bundle.

In a specific implementation, the product bundle generation system 104 generates dynamic primary product bundles according to the various implementations, and techniques described in related U.S. patent application Ser. No. 13/935,266. The product bundle can be dynamic in that the primary products that are presented to the user change within the product bundle after the bundle is created as the user interacts with the product bundle. For example, the product bundle can be dynamic in that the primary products change after the product bundle is created, but before the user begins interacting with the product bundle, such as during or before the user selects a product bundle link. Furthermore, the product bundle generation system 104 can generate dynamic product bundles that dynamically change which advertised products are presented to a user while interacting with the product bundle. As part of dynamically changing which advertised product are presented to a user, the dynamic product bundle can include conditions for advertised products that are used to determine what advertised products are presented to a user. For example, if advertised product A includes the condition to display it if the user downloads or selects primary product A, and the user downloads or selects primary product A, then the dynamic product bundle can be modified to present advertised product A to the user.

In a specific implementation, the product bundles generated by the product bundle generation system 104 include product links. Product links can be uniform resource locators (hereinafter URL). In particular, a product link can be a link or reference to a landing page in a network or the Internet from which the product, both primary and advertised, can be downloaded or from which a user can interact with the product. In one example, a product link is static in that it provides a reference or a link to a landing page for the same product. Furthermore, as a product link can be static, if a new version of the product is created, the new version can be assigned to a different static product link that is included as part of a product bundle. A user can download or interact with a specific version of a product by accessing the product link of a specific version of a product.

In a specific implementation, the product bundle generation system 104 generates a product bundle when a product developer requests creation of a product bundle. In one example, the product bundle generation system 104 can generate a product bundle when a product developer requests creation of a product bundle after creating a new product. For example, if a product developer creates a new word processing application and requests that a new product bundle is created for the new word processing application, the product bundle generation system 104 can create a new product bundle for the newly created product. Additionally, the product bundle generation system 104 can generate a product bundle when a product developer requests creation of a product bundle after creating a new version of a product.

In a specific implementation, the product bundle generation system 104 generates a product bundle when a distribution agent requests a product bundle. A distribution agent, as is used in this paper, can provide a system through which a user can access a bundle link, and subsequently download the product bundle or begin interacting with the product bundle generated by the product bundle generation system 104. For example, a distribution agent can be a website or Internet system that receives traffic from the Internet through which a user can access a product bundle, such as an Internet download directory system, e.g. Download.com®.

In a specific implementation, the product bundle datastore 106 functions to store product bundles. The product bundle datastore 106 stores product bundles generated by the product bundle generation system 104. Depending upon implementation-specific, configuration-specific, or other considerations, the product bundle datastore 106 can store product bundles in a hierarchical fashion based on a version of a primary product included in the product bundle. Additionally, the product bundle datastore 106 can store product bundles based on a developer of primary products included in product bundles. The product bundle datastore 106 can also store product bundles based on a distribution agent, for which the product bundle is created, and/or affiliates and partners associated with the product bundle.

The product bundle generation system 104 includes a tag injection system 108. In a specific implementation, the tag injection system 108 functions to inject tags into product bundles generated by the product bundle generation system 104. Tags can associate unique parameters with product bundles into which the tags are injected. Depending upon implementation-specific, configuration-specific, or other considerations, the tags injected by the tag injection system 108 can be part of key/value pairs that associate unique parameters with the product bundle. Additionally, the tags can be string-based identifier values that form part of the key/value pairs that associate unique parameters with the product bundle. In one example, tags associate unique parameters to product bundles associated with the distribution of the product bundles. In another example, tags associate unique parameters to product bundles related to user interaction with the product bundles.

In a specific implementation, tags injected into product bundles by the tag injections system 108 are used to perform analytics in measuring product bundle performance of the product bundles generated by the product bundle generation system 104. Depending upon implementation-specific, configuration-specific, or other considerations, parameters associated to a product bundle by tags can include analytic conditions that are used to perform analytics on the product bundles.

In a specific implementation, the tag injection system 108 injects the tags directly into executable code of a product bundle. By injecting tags directly into executable code of a product bundle, the tag injections system 108 can function to create, at least in part, product bundles that are unique, based on the injected tags. Specifically, the tag injection system 108 can function to make a product bundle unique based on a single tag injected into the product bundle or a combination of tags injected into the product bundle.

In a specific implementation, the client device 110 functions to download and/or interact with a product bundle. The client device 110 is a device that is capable of sending and receiving data through a network. In one example, the client device 110 is a device that is capable of sending and receiving data through the Internet. The client device 110 can be a thin client or an ultra-thin client.

In a specific implementation, the client device 110 functions to allow a user of the client device 110 to interact with product bundles generated by the product bundle generation system 104. Specifically, the client device 110 can allow a user to download or interact with product bundles by presenting a product bundle link to the user. In one example, a product bundle link provides a reference or a link to a landing page at which a user can download or interact with a product bundle. A product bundle link can be presented to a user of the client device 110 through a distribution agent. In interacting with a product bundle, a user can select, download, and/or interact with products included as part of the product bundle. Additionally, in functioning to allow a user to interact with a product bundle, the client device 110 can present product links to the products included as part of the product bundle. In one example, a product link provides a reference or link to a landing page, at which a user can download and/or interact with a specific product included as part of a product bundle.

In a specific implementation, the bundle analytics system 112 functions to perform analytics on product bundles generated by the product bundle generation system 104. The bundle analytics system 112 can perform analytics on product bundles during or after users interact with product bundles through the client device 110. Additionally, the bundle analytics system 112 can perform analytics on product bundles regarding the performance of the product bundles while users interact with the product bundles. In one example, the analytics can include the amount of revenue that the product bundle generates for an entity within a specific demographic or market. In another example, the analytics can also include the amount of revenue that the product bundle generates for an entity. Depending upon implementation-specific, configuration-specific, or other considerations, the bundle analytics system 112 can use tags injected into a product bundle by the injection system 108 to perform analytics on the product bundle. In performing analytics using tags, the tags can be associated with analytics conditions that are used by the bundle analytics system 112 to perform analytics on a product bundle.

In an example of operation of the example system shown in FIG. 1, the product bundle generation system 104 functions to generate product bundles 104. The product bundles are stored in the product bundle datastore 106. In the example of operation, the product bundle generation system 104 includes a tag injection system 108 that functions to inject tags into generated product bundles. Further in the example of operation, a user interacts with the product bundles stored in the product bundles datastore through the client device 110. In one example the product bundle is delivered to or accessed from the client device 110 through a distribution agent. Still further in the example of operation, the bundle analytics system 112 functions to perform analytics on product bundles based on user interaction with the product bundles. In the example of operation, the bundle analytics system 112 uses the tags injected to the product bundles by the tag injection system 108 to perform analytics on the product bundles.

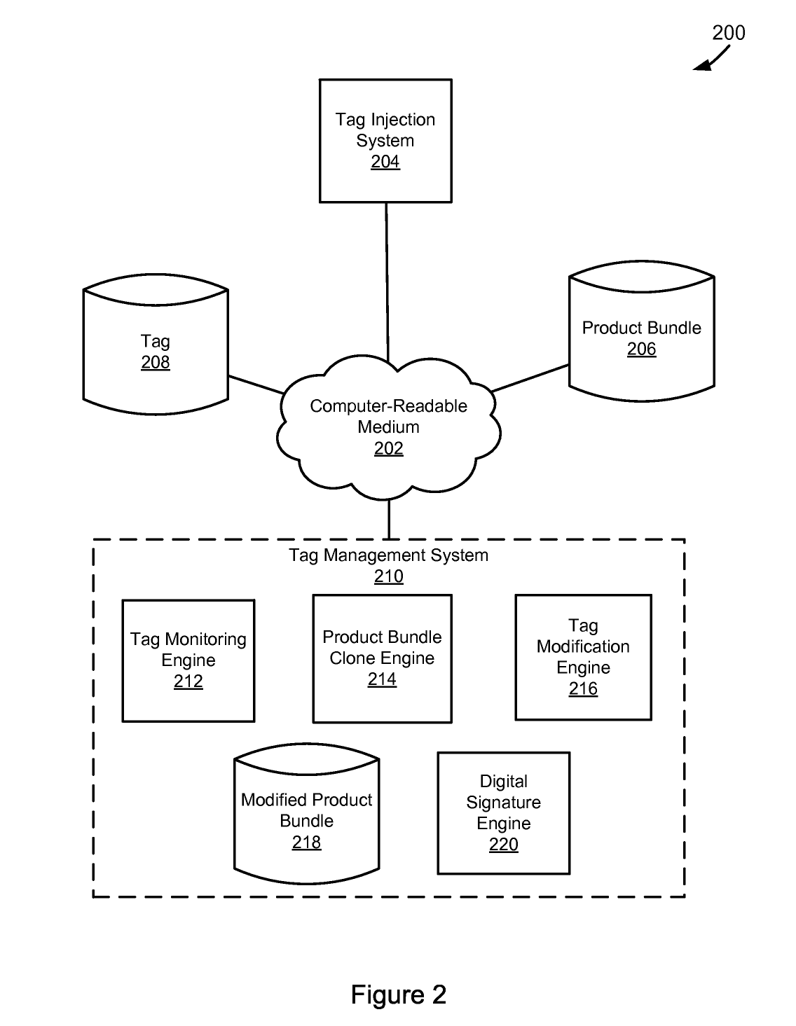

FIG. 2 depicts a diagram 200 of an example of a system for generating and controlling mutable and immutable tags in a product bundle. The example system shown in FIG. 2 includes a computer-readable medium 202, a tag injection system 204, a product bundle datastore 206, a tag datastore 208, and a tag management system 210. In the example system shown in FIG. 2, the tag injection system 204, the product bundle datastore 206, the tag datastore 208, and the tag management system 210 are coupled to each other through the computer-readable medium 202.

In a specific implementation, the tag injection system 204 functions according to an applicable system for injecting tags into a product bundle, such as the tag injections systems described in this paper. Depending upon implementation-specific, configuration-specific, or other considerations, the tag injection system 204 can inject tags that associated unique parameters to a product bundle in which the tags are injected. As part of injecting tags into a product bundle, the tag injection system 204 can inject tags directly into executables of the product bundle.

In a specific implementation, the product bundle 206 functions according to an applicable datastore for storing product bundles, such as the product bundle datastores described in this paper. In one example, the product bundle datastore 206 stores product bundles generated by a product bundle generation system. Product bundles stored by the product bundle datastore 206 can include tags injected into the product bundles by the tag injection system 204.

In a specific implementation, the tag injection system 204 functions to inject immutable tags into a product bundle. Immutable tags injected by the tag injection system 204 can be stored in the tag datastore 208 or various other applicable tag datastores described in this paper. Depending upon implementation-specific, configuration-specific, or other considerations, immutable tags can be constants that do not change throughout the life of the product bundle. For example, immutable tags can be constants that do not change as a distribution agent presents a product bundle link to a user and the user uses the link to access a landing page at which a user can download or interact with the product bundle. Furthermore, immutable tags can be constants that do not change as a user interacts with a product bundle. Specifically, in one example, the immutable tags are constants that do not change as the user is presented with and/or activates product links that reference landing pages from which the user can download or interact with a specific product in the product bundle. In another example, immutable tags are constants that do not change when a user downloads and/or interacts with a product included in the product bundle from a landing page referenced by the product link.

In a specific implementation, the tag injection system 204 functions to inject mutable tags into a product bundle. Mutable tags injected by the tag injection system 204 can be stored in the tag datastore 208 or various other applicable tag datastores described in this paper. Depending upon implementation-specific, configuration-specific, or other considerations, mutable tags can be variables that change after being injected into the product bundle during the life of the product bundle. For example, mutable tags can be variables that can change as the product bundle is created. Specifically, in one example, mutable tags can be variables that can change as a distribution agent presents a product bundle link to a user. In another example, mutable tags can be variables that can change as a user uses the product bundle link to access a landing page at which a user can download or interact with the product bundle. Additionally, mutable tags can also be variables that can change as a user interacts with a product bundle. For example, mutable tags can be variables that can change as the user is presented with and/or activates product links that reference landing pages from which the user can download or interact with a specific product in the product bundle. In another example, mutable tags can be variables that change when a user downloads and/or interacts with a product included in the product bundle using a landing page referenced by the product link.

In a specific implementation, the tag management system 210 functions to manage tags injected by the tag injection system 204 into a product bundle. The tag management system 210 can function to manage tags within a product bundle as the product bundle is created. Additionally, the tag management system 210 can manage tags within a product bundle as a distribution agent presents a product bundle link to a user. For example, the tag management system 210 can manage tags within a product bundle as a user uses the product bundle link to access a landing page at which a user can download or interact with the product bundle. Furthermore, the tag management system 210 can manage tags within a product bundle as a user interacts with the product bundle. For example, the tag management system 210 can manage tags within a product bundle as a user is presented with and/or activates product links that references a landing page from which the user can download or interact with a specific product in the product bundle. In another example, the tag management system 210 can manage tags within a product bundle as a user downloads and/or interacts with a product included in the product bundle using a landing page referenced by the product link.

The tag management system 210 includes a tag monitoring engine 212, a product bundle clone engine 214, a tag modification engine 216, a modified product bundle datastore 218, and a digital signature engine 220. Depending upon implementation-specific, configuration-specific, or other considerations, the tag management system 210 can be included as part of an installer for a product bundle. Additionally, Depending upon implementation-specific, configuration-specific, or other considerations, the tag management system 210 can also be included as part of an application that allows a user to interact with a product bundle.

In a specific implementation, the tag monitoring engine 212 functions to determine whether a mutable tag should be changed in a product bundle, and what the mutable tag should be changed to in the product bundle. For example, if a tag identifies a region in which a product bundle is distributed by a distribution agent and the product bundle is distributed in a different region by either the same or a different distribution agent, then the tag monitoring engine 212 can determine that the tag needs to be changed and that it should be changed to the value that associates the product bundle with a parameter that signifies the region in which the product bundle is distributed. Based upon determining whether a tag should change, the tag monitoring engine 212 can also function to generate tag modification data. Tag modification data, generated by the tag monitoring engine 212, can identify information related to the modification of tags in a product bundle. By way of example, tag modification data generated by the tag monitoring engine 212 can include the identification of a product bundle that has tags that need to be changed, the identification of mutable tags in the product bundle that need to be changed, and what the mutable tags should be changed to within a product bundle.

In a specific implementation, the tag monitoring engine 212 functions to determine whether a mutable tag should be changed in a product bundle, and what the mutable tag should be changed to in the product bundle during the life of the product bundle. The tag monitoring engine 212 can determine whether a mutable tag should be changed and what the mutable tag should be changed to within a product bundle as the product bundle is created. The tag monitoring engine 212 can also determine whether a mutable tag should be changed and what the mutable tag should be changed to within a product bundle as a distribution agent presents a product bundle link to a user. For example, the tag monitoring engine 212 can determine whether a mutable tag should be changed and what the mutable tag should be changed to within a product bundle as a user uses the product bundle link to access a landing page at which a user can download or interact with the product bundle. Additionally, the tag monitoring engine 212 can determine whether a mutable tag should be changed and what the mutable tag should be changed to within a product bundle as a user interacts with the product bundle. For example, the tag monitoring engine 212 can determine whether a mutable tag should be changed and what the mutable tag should be changed to within a product bundle as a user is presented with and/or activates a product link that references a landing page from which the user can download or interact with a specific product in the product bundle. In another example, the tag monitoring engine 212 can also determine whether a mutable tag should be changed and what the mutable tag should be changed to within a product bundle as a user downloads and/or interacts with a product included in the product bundle using a landing page referenced by a product link.

In a specific implementation, the product bundle clone engine 214 functions to clone product bundles. Depending upon implementation-specific, configuration-specific, or other considerations, the product bundle clone engine 214 can clone a product bundle, including the executables of the product bundle, based on whether it is determined by the tag monitoring engine 212 that a tag in the product bundle needs to be changed. Furthermore, the product bundle clone engine 214 can clone a product bundle according to tag modification data generated by the tag monitoring engine 212. For example, if the tag monitoring engine 212 determines that a tag injected into a product bundle needs to be changed, then the product bundle clone engine 214 can clone the product bundle as indicated by the tag modification data.

In a specific implementation, the tag modification engine 216 function to modify the tags in a product bundle, thereby creating a modified product bundle. In one example of modifying tags in a product bundle, the tag modification engine 216 can change mutable tags in the product bundle. In another example of modifying tags in a product, the tag modification engine 216 can add new tags to the product bundle. Depending upon implementation-specific, configuration-specific, or other considerations, the tag modification engine 216 can modify tags in a cloned version of a product bundle cloned by the product bundle clone engine 214 to create a modified product bundle. The tag modification engine 216 can modify tags in a cloned product bundle according to tag modification data generated by the tag monitoring engine 212. For example, if the tag modification data indicates that a tag of type A needs to be changed to type B, then the tag modification engine 216 can change the tag of type A to type B.

In a specific implementation, the modified product bundle datastore 218 functions to store the modified product bundles. Further in the implementation, the modified product bundle datastore 218 stores modified product bundles generated by the tag modification engine 216.

In a specific implementation, a modified product bundle stored in the modified product bundle datastore 218 is pushed back to a client at a point in the life of the product bundle at which it is determined that the product bundle should be modified. For example, if the product bundle was modified when the product bundle link was presented to the user, then a product bundle link to the modified product bundle can be presented to the user after the product bundle is modified. In another example, if a product in the product bundle is modified after a user activates a product bundle link and is at the landing page where the user can interact with or download the product bundle, then the landing page can allow the user to interact with or download the modified product bundle. In yet another example, if a product in the product bundle is modified when a product link to the product is displayed to the user, then a product link to a product in the modified product bundle can be presented to the user after the product bundle is modified.

In a specific implementation, the tag monitoring engine 212 functions to determine whether a mutable tag should be changed and what the mutable tag should be changed to in a modified product bundle stored in the modified product bundle datastore 218. The tag monitoring engine 212 can generate tag modification data. In one example, tag modification data, generated by the tag monitoring engine 212, identifies a modified product bundle that contains mutable tags that need to be changed, what mutable tags need to be changed in a modified product bundle, and what the mutable tags need to be changed to in the modified product bundle. For example, if the tag modification engine 216 modifies a product bundle to replace an old tag with a new tag when a product bundle link is presented to a user, thereby creating a modified product bundle, and the tag monitoring engine 212 determines that tags in the modified product bundle should be changed once a user is at a landing page for the modified product bundle, then the tag monitoring engine 212 can generate tag modification data used to further modify the modified product bundle.

In a specific implementation, the product bundle clone engine 214 functions to clone a modified product bundle. The product bundle clone engine 214 can clone a modified product bundle based on whether it is determined by the tag monitoring engine 212 that a tag in the modified product bundle needs to be changed. Depending upon implementation-specific, configuration-specific, or other considerations, the product bundle clone engine 214 can clone a modified product bundle based on tag modification data generated by the tag monitoring engine 212. For example, if the tag monitoring engine 212 determines that a tag in a modified product bundle needs to be changed, then the product bundle clone engine 214 can clone the modified product bundle.

In a specific implementation, the tag modification engine 216 functions to modify the tags in a modified product bundle. In one example of modifying the tags in a modified product bundle, the tag modification engine 216 can change the values of mutable tags in a modified product bundle. In another example of modifying the tags in a modified product bundle, the tag modification engine 216 can inject new tags into a modified product bundle. Depending upon implementation-specific, configuration-specific, or other considerations, the tag modification engine 216 can modify tags in a cloned version of a modified product bundle cloned by the product bundle clone engine 214. Additionally, the tag modification engine 216 can modify tags in a cloned version of a modified product bundle based on tag modification data generated by the tag monitoring engine 212. For example, if tag modification data indicates that a tag of type A in the modified product bundle needs to be changed to type B, then the tag modification engine 216 can change the tag of type A to type B.

In a specific implementation, the digital signature engine 220 functions to determine whether all of the modifications have been made to a product bundle, such that a product bundle or a modified product bundle is the final version of the product bundle. As used herein, a final version of a product bundle can be a version of a product bundle in which tags injected into the product bundle will not change further during the life of a product bundle. For example, if a product bundle will be deployed to a user in region A and a tag is injected into the product bundle that signifies region A to form a modified product bundle, then the modified product bundle is a final version of the product bundle.

In a specific implementation, the digital signature engine 220 functions to add a digital signature to a product bundle/modified product bundle. Depending upon implementation-specific or other considerations, the digital signature engine 220 can insert a digital signature into a product bundle/modified product bundle, after it determines that the product bundle/modified product bundle is a final version of the product bundle. Further in the specific implementation, a digital signature inserted into a product bundle/modified product bundle can be broken if an attempt to change the executable or tags of the product bundle occurs. For example, if an attempt to change a region tag in a product bundle/modified product bundle occurs, then a digital signature of the product bundle can be broken. Whether a digital signature in a product bundle/modified product bundle has been broken can be used to determine whether improper usage of the product bundle/modified product bundle has occurred. In various implementations, digital signatures added to a product bundle/modified product bundle can be used to determine whether piracy has occurred and used to prevent piracy of products included in the product bundle/modified product bundle.

In an example of operation of the example system shown in FIG. 2, the tag injection system functions to inject tags into a product bundle. Further in the example of operation, the product bundle, with the injected tags are stored in the product bundle datastore 206. Still further in the example of operation, the tag injection system 204 injects immutable tags, stored in the tag datastore 208, into the product bundle. Further in the example of operation, the tag injection system 204 injects mutable tags, stored in the tag datastore 208, into the product bundle.

In the example of operation, the tag management system 210 manages tags injected into the product bundle by the tag injection system 204. Further in the example of operation, the tag monitoring engine 212 generates tag modification data. In the example of operation, the product bundle clone engine 214 generates a clone of product bundles, including injected tags, in the product bundle based on the tag modification data. Still further in the example of operation, the tag modification engine 216 injects new tags or changes tags in a cloned version of a product bundle cloned by the product bundle clone engine 214 according to the tag modification data generated by the mutable tag modification engine 214 to generated modified product bundles. Further in the example of operation, the modified product bundles are stored in the modified product bundle datastore 218.

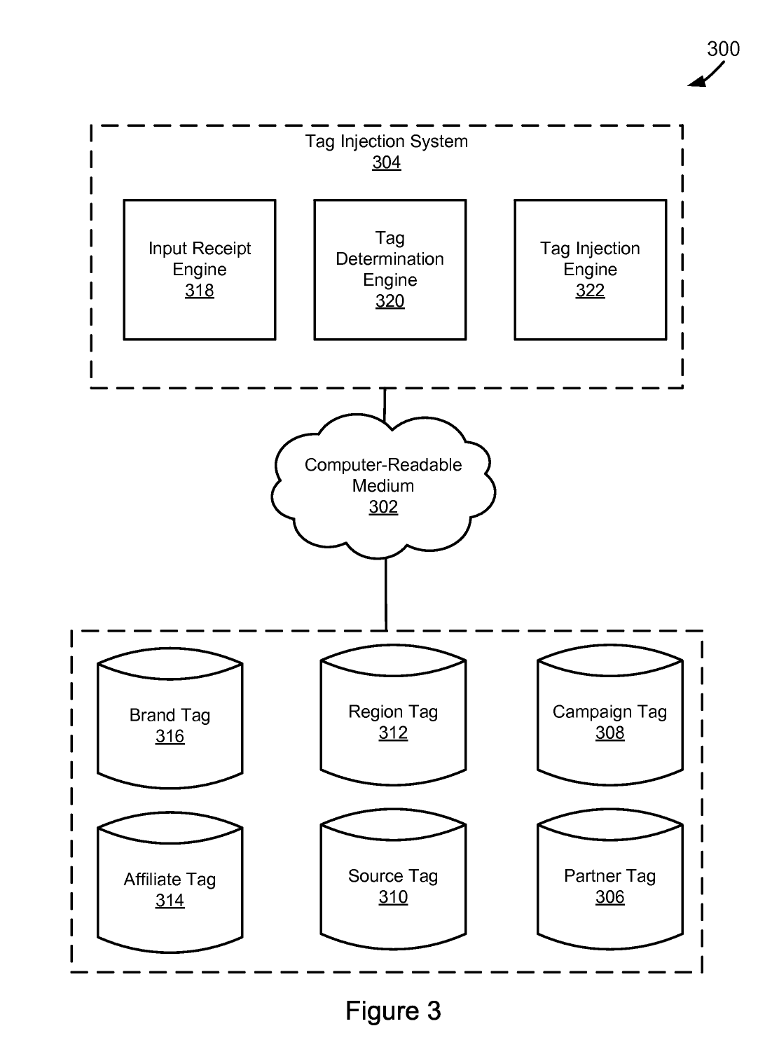

FIG. 3 depicts a diagram 300 of an example of a system for injecting tags into a product bundle. The system of FIG. 3 includes a computer-readable medium 302, a tag injection system 304, a partner tag datastore 306, a campaign tag datastore 308, a source tag datastore 310, a region tag datastore 312, an affiliate tag datastore 314, and a brand tag datastore 316. Further in the example system shown in FIG. 3, the tag injection system 304, the partner tag datastore 306, the campaign tag datastore 308, the source tag datastore 310, the region tag datastore 312, the affiliate tag datastore 314, and the brand tag datastore 316 are coupled to each other through the computer-readable medium 302.

In a specific implementation, the tag injection system 304 functions according to an applicable system for injecting tags into a product bundle, such as the tag injection systems described in this paper. The tag injection system 304 can inject tags into a product bundle, as the product bundle is created. Depending upon implementation-specific, configuration-specific, or other considerations, tags injected into a product bundle by the tag injection system 304 can be immutable tags. Further depending upon implementation-specific, configuration-specific, or other considerations, tags injected into a product bundle by the tag injection system 304 can be mutable tags. The tag injection system 304 can inject partner tags stored in the partner tag datastore 306 into a product bundle. Further, the tag injection system 304 can inject campaign tags stored in the campaign tag datastore 308 into a product bundle. Additionally, the tag injection system 304 can inject source tags stored in the source tag datastore 310 into a product bundle. Furthermore, the tag injection system 304 can inject region tags stored in the region tag datastore 312 into a product bundle. The tag injection system 304 can also inject affiliate tags stored in the affiliate tag datastore 314 into a product bundle. Further, the tag injection system 304 can inject brand tags, stored in the brand tag datastore 316 into a product bundle.

In a specific implementation, the partner tag datastore 306 functions to store partner tags. In one example, a partner tag is an immutable tag that is a constant that does not change during the life of a product bundle. In another example, a partner tag is a mutable tag that is a variable that can change during the life of a product bundle.

In a specific implementation, partner tags stored in the partner tag datastore 306 associate partner parameters with a product bundle in which the partner tags are injected. A partner can be a distribution agent or an entity generating traffic for accessing the product bundle, such as Download.com®. A partner can also be an entity providing the systems for creating a product bundle. Additionally, a partner can be a developer of a product in the product bundle. For example, a partner can be a developer of a primary product in a product bundle. The partner parameters can identify a particular partner. Partner parameters can provide a reference to analytics conditions associated with a partner. For example, a partner parameter can provide a reference to analytics conditions that specify a revenue sharing model for a partner. The partner tags can be used to associate one or a plurality of product bundles with different partner parameters that reference different analytics conditions for the same partner. For example, a partner can have a different revenue sharing model for a first product inserted into a product bundle than a revenue sharing model for a second product inserted into a product bundle.

In a specific implementation, the campaign tag datastore 308 functions to store campaign tags. In one example, a campaign tag is an immutable tag that is a constant that does not change during the life of a product bundle. In another example, a campaign tag is a mutable tag that is a variable that can change during the life of a product bundle.

In a specific implementation, campaign tags stored in the campaign tag datastore 308 associate campaign parameters with a product bundle in which the campaign tags are injected. A campaign can be an advertising campaign that involves the product bundle. Specifically, a campaign can be a specific advertising campaign for a product within the product bundle. Furthermore, a campaign can be an advertising campaign for a primary product and/or an advertised product in the product bundle. A campaign can be set up or determined by a developer of a product in the product bundle. Additionally, a campaign can be set up or determined by the entity that provides the systems for creating the product bundle. A campaign parameter can include the identification of a particular campaign that the campaign parameter is associated with or represents. Additionally, a campaign parameter can include a reference to the length of time of the campaign that the campaign parameter is associated with or represents. Furthermore, a campaign parameter can include the identification of an advertisement network in which a product bundle is advertised or displayed.

In a specific implementation, the source tag datastore 310 functions to store source tags. In one example, a source tag is an immutable tag that is a constant that does not change during the life of a product bundle. In another example, a source tag is a mutable tag that is a variable that can change during the life of a product bundle.

In a specific implementation, source tags stored in the source tag datastore 310 associate source parameters with a product bundle in which the source tags are injected. A source parameter can identify a source of network traffic through which a user accesses the product bundle in the network. A source can be an advertisement network, such as Google®, through which a user accesses the product bundle. For example, if a user was presented with an advertisement for accessing the product bundle and accesses the product bundle through the advertisement while performing a Google® search, then Google® can be a source.

In a specific implementation, the region tag datastore 312 functions to store region tags. In one example, a region tag is an immutable tag that is a constant that does not change during the life of a product bundle. In another example, a region tag is a mutable tag that is a variable that can change during the life of a product bundle.

In a specific implementation, region tags stored in the region tag datastore 312 associate region parameters with a product bundle in which the region tags are injected. A region parameter can identify a particular region or location within the world. Additionally, a region can be a location within the world where a user downloads or interacts with the product bundle. Furthermore, a region can be a location within the world where a user downloads or interacts with a product in the product bundle. A region can be detected when a user accesses a landing page where the user can interacts with or download the product bundle. Additionally, a region can be dynamically detected as a user continues to interact with the product bundle over time. A region of a user can be detected through a geographical detection service. Additionally, a region can be detected through browser region settings of the browser that the user uses to access the landing page at which the user downloads or interacts with the product bundle. In one example, a region tag that is a blank variable is removed from a product bundle and a region tag that represents a particular region or location within the world where the user downloads or interacts with the product bundle is injected into the product bundle once the user downloads or interacts with the product bundle.

In a specific implementation, the affiliate tag datastore 314 functions to store affiliate tags. In one example, an affiliate tag is an immutable tag that is a constant that does not change during the life of a product bundle. In another example, an affiliate tag is a mutable tag that is a variable that can change during the life of a product bundle.

In a specific implementation, affiliate tags stored in the affiliate tag datastore 314 associate affiliate parameters with a product bundle in which the affiliate tags are injected. An affiliate parameter can identify one or a plurality of affiliates. An affiliate can be an advertisement network in which a product bundle is advertised or displayed. An affiliate can also be a source of network traffic through which a user accesses the product bundle in the network. Additionally an affiliate can be a distribution agent such as Download.com®. An affiliate can also be a product developer of products included within a product bundle. In one example, the affiliate tag can be a blank variable that is changed once a user accesses a landing page from which the user interacts with or downloads the product bundle. In another example, the affiliate tags are injected at product bundle creation time according to a partner.

In a specific implementation, the brand tag datastore 316 functions to store brand tags. In one example, a brand tag is an immutable tag that is a constant that does not change during the life of a product bundle. In another example, a brand tag is a mutable tag that is a variable that can change during the life of a product bundle.

In a specific implementation, brand tags stored in the brand tag datastore 316 associate brand parameters with a product bundle in which the brand tags are injected. A brand parameter can identify a brand. A brand can be the domain through which a product bundle link is presented to the user and the user gains access to a landing page in which a user can interact with or download a product bundle. Furthermore, a brand parameter can identify a domain of a distribution agent through which a product bundle link is presented to the user and the user gains access to a landing page in which a user can interact with or download a product bundle. In one example, a brand tag is a blank variable that is replaced when a user accesses a landing page where a user can interact with or download a product bundle.

The tag injection system 304 includes an input receipt engine 318, a tag determination engine 320, and a tag injection engine 322. In a specific implementation, the input receipt engine 318 functions to receive tag injection input regarding the injection of tags into a product bundle. Depending upon implementation-specific, configuration-specific, or other considerations, the input receipt engine 318 can function to receive tag injection input regarding the injection of one or a combination of partner tags, campaign tags, source tags, regions tags, affiliate tags, and brand tags stored in the corresponding partner tag datastore 306, the campaign tag datastore 308, the source tag datastore 310, the region tag datastore 312, the affiliate tag datastore 314, or the brand tag datastore 316. Tag injection input can be received from an entity requesting a product bundle. Additionally, tag injection input can be received from a distribution agent, a product developer, and/or an entity that provides the system for generating product bundles. Tag injection input can indicate specific tags to inject into the product bundle. For example, tag injection input can indicate a partner tag to inject into the product bundle.

In a specific implementation, the tag determination engine 320 functions to determine what tags to inject into a product bundle. Depending upon implementation-specific, configuration-specific, or other considerations, the tag determination engine 320 can function to determine one or a combination of partner tags, campaign tags, source tags, regions tags, affiliate tags, and brand tags stored in the corresponding partner tag datastore 306, the campaign tag datastore 308, the source tag datastore 310, the region tag datastore 312, the affiliate tag datastore 314, or the brand tag datastore 316 to inject into a product bundle. The tag determination engine 320 can determine what tags to inject into a product bundle based on tag injection input received from the tag injection engine 322. For example, the tag determination engine 320 can determine to insert a specific partner tag based on tag injection input that indicates the specific partner tag. Additionally, the tag determination engine 320 can determine what tag to inject based on whether tag injection input indicating a specific tag to inject into the product bundle exists. For example, if tag injection input does not indicate a region tag to insert into a product bundle, then the tag determination engine 320 can determine to insert a region tag that is a blank variable into the product bundle.

In a specific implementation, the tag injection engine 322 functions to inject tags into a product bundle. Depending upon implementation-specific, configuration-specific, or other considerations, the tag injection engine 322 can function to inject one or a combination of partner tags, campaign tags, source tags, regions tags, affiliate tags, and brand tags stored in the corresponding partner tag datastore 306, the campaign tag datastore 308, the source tag datastore 310, the region tag datastore 312, the affiliate tag datastore 314, or the brand tag datastore 316 into a product bundle. The tag injection engine 322 can inject tags determined by the tag determination engine 320.

In an example of operation of the example system shown in FIG. 3, the partner tag datastore 306 stores partner tags. Further in the example of operation, the campaign tag datastore 308 stores campaign tags. Also in the example of operation, the source tag datastore 310 stores source tags. Still further in the example of operation, the region tag datastore 312 stores region tags. Further in the example of operation, the affiliate tag datastore 314 stores affiliate tags. Also in the example of operation, the brand tag datastore 316 stores brand tags.

Additionally in the example of operation the input receipt engine 318 receives tag injection input regarding the injection of one or a combination of partner tags, campaign tags, source tags, regions tags, affiliate tags, and brand tags stored in the corresponding partner tag datastore 306, the campaign tag datastore 308, the source tag datastore 310, the region tag datastore 312, the affiliate tag datastore 314, or the brand tag datastore 316. Further in the example of operation, the tag determination engine 320 functions to determine a product bundle to inject one or a combination of partner tags, campaign tags, source tags, regions tags, affiliate tags, and brand tags stored in the corresponding partner tag datastore 306, the campaign tag datastore 308, the source tag datastore 310, the region tag datastore 312, the affiliate tag datastore 314, or the brand tag datastore 316 into based on tag injection input received by the input receipt engine 318. Still further in the example of operation the tag injection engine 322 functions to inject one or a combination of partner tags, campaign tags, source tags, regions tags, affiliate tags, and brand tags stored in the corresponding partner tag datastore 306, the campaign tag datastore 308, the source tag datastore 310, the region tag datastore 312, the affiliate tag datastore 314, or the brand tag datastore 316 into in a product bundle based on determinations made by the tag determination engine 320.

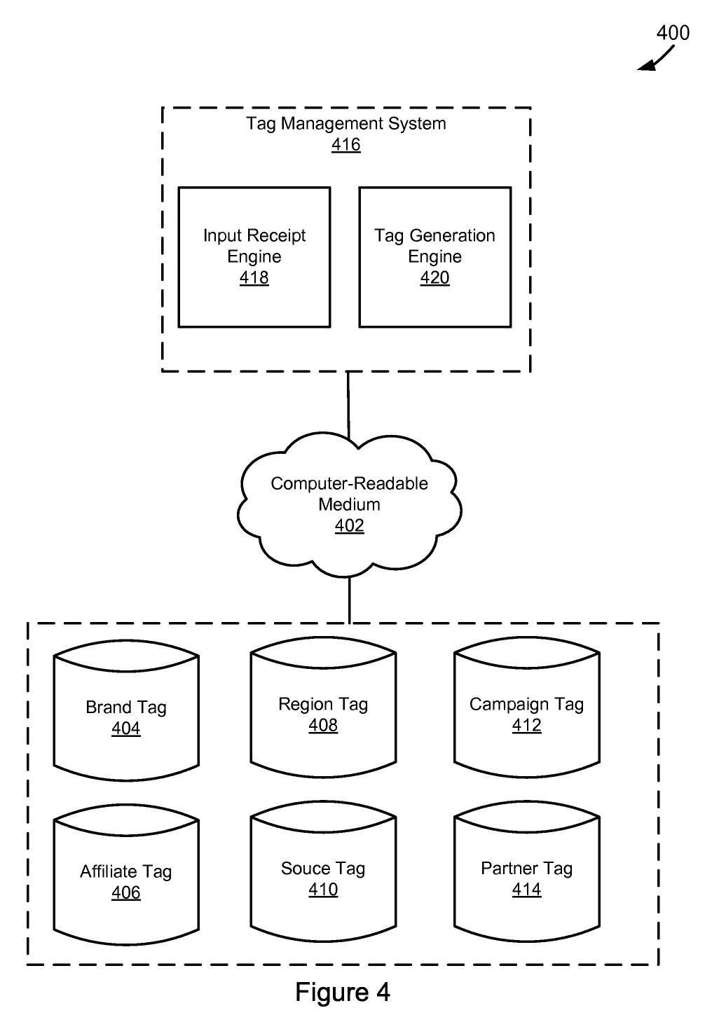

FIG. 4 depicts a diagram 400 of an example of a system for generating tags. The system of FIG. 4 includes a computer-readable medium 402, a brand tag datastore 404, an affiliate tag datastore 406, a region tag datastore 408, a source tag datastore 410, a campaign tag datastore 412, a partner tag datastore 414, and a tag management system 416. The brand tag datastore 404, the affiliate tag datastore 406, the region tag datastore 408, the source tag datastore 410, the campaign tag datastore 412, the partner tag datastore 414, and the tag management system 416 are coupled to each other through the computer-readable medium 402.

In a specific implementation, the brand tag datastore 404 functions according to an applicable datastore for storing brand tags, such as the brand tag datastores described in this paper. The brand tag datastore 404 can store brand tags that are immutable. The brand tag datastore 404 can also store brand tags that are mutable.

In a specific implementation, the affiliate tag datastore 406 functions according to an applicable datastore for storing affiliate tags, such as the affiliate tag datastores described in this paper. The affiliate tag datastore 406 can store affiliate tags that are immutable. The affiliate tag datastore 406 can also store affiliate tags that are mutable.

In a specific implementation, the region tag datastore 408 functions according to an applicable datastore for storing region tags, such as the region tag datastores described in this paper. The region tag datastore 408 can store region tags that are immutable. The region tag datastore 408 can also store region tags that are mutable.

In a specific implementation, the source tag datastore 410 functions according to an applicable datastore for storing source tags, such as the source tag datastores described in this paper. The source tag datastore 410 can store source tags that are immutable. The source tag datastore 410 can also store source tags that are mutable.

In a specific implementation, the campaign tag datastore 412 functions according to an applicable datastore for storing campaign tags, such as the campaign tag datastores described in this paper. The campaign tag datastore 412 can store campaigns tags that are immutable. The campaign tag datastore 412 can also store mutable campaign tags that are mutable.

In a specific implementation, the partner tag datastore 414 functions according to an applicable datastore for storing partner tags, such as the partner tag datastores described in this paper. The partner tag datastore 414 can store partner tags that are immutable. The partner tag datastore 414 can also store partner tags that are mutable.

In a specific implementation, the tag management system 416 functions according to an applicable system for managing tags in product bundles, such as the tag management systems described in this paper. In managing tags, the tag management system 416 can function to generate and/or update tags in product bundles. The tags managed by the tag management system 416 can include brand tags injected from the brand tag datastore 404 affiliate tags injected from the affiliate tag datastore 406, region tags injected from the region tag datastore 408, source tags injected from the source tag datastore 410, campaign tags injected from the campaign tag datastore 412, and partner tags injected from the partner tag datastore 414.

The tag management system 416 includes an input receipt engine 418 and a tag generation engine 420. In a specific implementation the input receipt engine 418 functions to receive tag generation input. Tag generation input can indicate a new tag to be generated by the tag management system 416. Tag generation input can also indicate an analytic condition associated with a tag, either already created or to be created by the tag management system 416. Additionally, tag generation input can indicate a change to an already existing tag. In one example, tag generation input can be received from a developer of products included in product bundles. Tag generation input can also be received from a distribution agent, an entity that provides the systems for generating product bundles, a partner, an affiliate, an advertisement network, and/or a source of network traffic, through which a user accesses a product bundle.

In a specific implementation, the tag generation engine 420 functions to generate tags. The tag generation engine 420 can generate brand tags stored in the brand tag datastore 404, affiliate tags stored in the affiliate tag datastore 406, region tags stored in the region tag datastore 408, source tags stored in the source tag datastore 410, campaign tags stored in the campaign tag datastore 412, and partner tags stored in the partner tag datastore 414. The tag generation engine 420 can generate tags based on tag generation input received by the input receipt engine 418. For example, if tag generation input received by the input receipt engine 418 indicates a new partner to create a partner tag for, the tag generation engine 420 can create a partner tag for the new partner. In another example, if tag generation input received by the input receipt engine 418 indicates a change to a partner tag, the tag generation engine 420 can update a partner tag according to the tag generation input.

In an example of operation of the example system shown in FIG. 4, the brand tag datastore 404 stores brand tags. In the example of operation, the affiliate tag datastore 406 stores affiliate tags. Further in the example of operation, the region tag datastore 408 stores region tags. Still further in the example of operation, the source tag datastore 410 stores source tags. In the example of operation, the campaign tag datastore 412 stores campaign tags. Still further in the example of operation, the partner tag datastore 414 stores partner tags. Further in the example of operation, the input receipt engine 418 receives tag generation input. Still further in the example of operation, the tag generation engine 420 generates and/or updates tags based on tag generation input received by the input receipt engine 418.

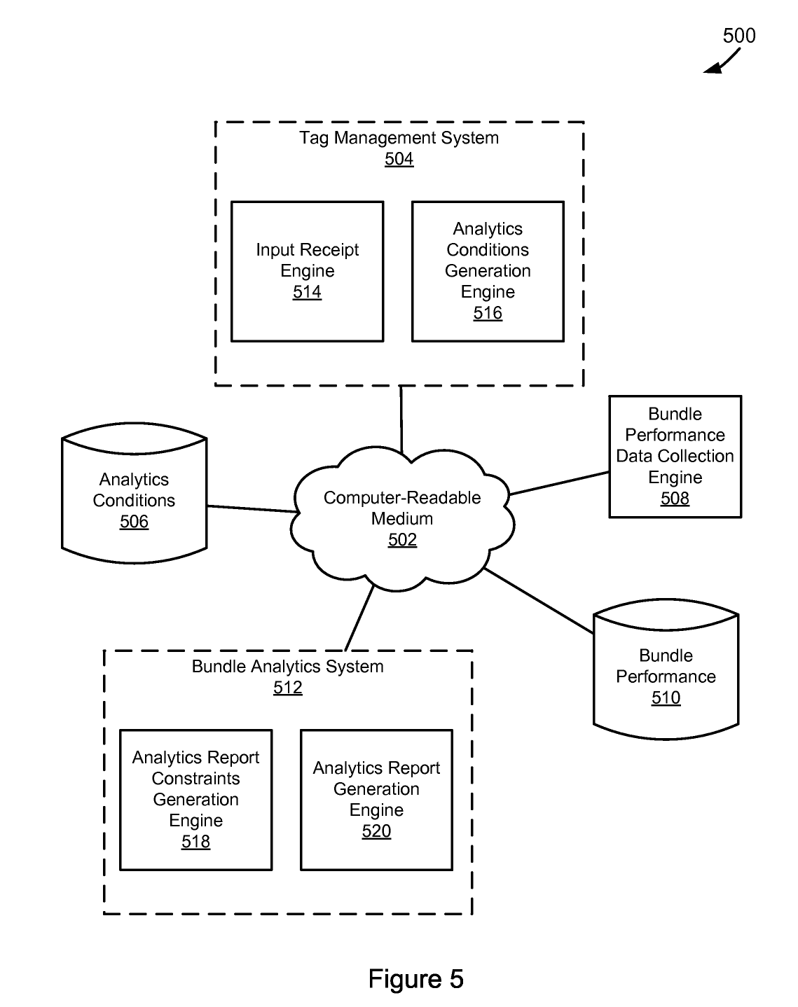

FIG. 5 depicts a diagram 500 of an example of a system for performing bundle analytics on bundles with injected tags. The system of FIG. 5 includes a computer-readable medium 502, a tag management system 504, an analytics conditions datastore 506, a bundle performance data collection engine 508, a bundle performance datastore 510, and a bundle analytics system 512. The tag management system 504, the analytics conditions datastore 506, the bundle performance data collection engine 508, the bundle performance datastore 510, and the bundle analytics system 512 are coupled to each other through the computer-readable medium 502.

In a specific implementation, the tag management system 504 functions according to an applicable tag management system, such as the tag management systems described in this paper. The tag management system 504 can generate tags. The tag management system 504 can also update already created tags.

The tag management system 504 includes an input receipt engine 514 and an analytics conditions generation engine 516. In a specific implementation, the input receipt engine 514 functions to receive tag generation input. Tag generation input can be received from a developer of products included in product bundles, a distribution agent, an entity that provides the systems for generating product bundles, a partner, an affiliate, an advertisement network, and/or a source of network traffic, through which a user accesses a product bundle.

In a specific implementation, tag generation input received by the input receipt engine 514 specifies analytics conditions associated with a tag. In one example, tag generation input can specify an analytics condition associated with a new tag that is specified by the tag generation input. In another example tag generation input can specify an analytics condition associated with an already existing tag. An already existing tag can be stored in an applicable tag datastore, such as the tag datastores described in this paper. Analytics conditions can be associated with parameters that are associated by the tags to the product bundles, in which the tags are injected. Analytics conditions can be conditions that are used in performing analytics for the product bundles. For example, an analytics condition can specify the revenue sharing for a partner associated to a product bundle by a specific tag. In another example, an analytics condition can specify the revenue sharing between partners and affiliates in a region associated to a product bundle by a specific tag.

In a specific implementation, tag generation input received by the input receipt engine 514 specifies analytics report constraints. Analytics report constraints can be constraints that are used to generate an analytics report. Specifically, in one example, analytics report constraints can specify tags for which to generate an analytics report. For example, the analytics report constraints can specify to generate an analytics report for product bundles with partner tags that associate a specific partner to a product bundle. In another example, the analytics report constraints can specify to generate an analytics report for product bundles with regions tags that associate a specific region to a product bundle.

In a specific implementation, the analytics conditions generation engine 516 functions to generate analytics conditions. The analytics conditions generation engine 516 can generate analytics conditions based on tag generation input received by the input receipt engine 514. For example, the analytics conditions generation engine 516 can generate an analytics condition that indicates revenue sharing for a partner based on tag generation input for a tag that associates the partner with the product bundle in which the tag is injected.

In a specific implementation, the analytics conditions datastore 506 functions to store analytics conditions. The analytics conditions datastore 506 can store analytics conditions generated by the analytic conditions generation engine 516.

In a specific implementation, analytics conditions are stored in the analytics conditions datastore 506 with condition identifiers that indicate the entities of which the analytics conditions are associated. Analytics conditions can be stored with condition identifiers that indicate partners of which the analytics conditions are associated. Additionally, analytics conditions can be stored with condition identifiers that indicate product developers of which the analytics conditions are associated. Furthermore, analytics conditions can be stored with condition identifiers that indicate distribution agents of which the analytics conditions are associated. Analytics conditions can also be stored with condition identifiers that indicate entities that provide the systems for generation product bundles of which the analytics conditions are associated. Additionally, analytics conditions can be stored with condition identifiers that indicate affiliates of which the analytics conditions are associated. Furthermore, analytics conditions can be stored with condition identifiers that indicate advertisement networks of which the analytics conditions are associated. Analytics conditions can also be stored with condition identifiers that indicate a source of network traffic, through which a user accesses a product bundle of which the analytics conditions are associated.

In a specific implementation, the bundle performance data collection engine 508 functions to collect bundle performance data. The bundle performance data collection engine 508 can store collected bundle performance data in the bundle performance datastore 510. Bundle performance data can include tags in product bundles. Specifically, in one example, bundle performance data can include the mutable tags in product bundles that change during the life of the product bundle as a user interacts with the product bundle. For example, if a region tag is changed, as a user interacts with a product bundle, based on the location of the user, then the bundle performance data can include the changed region tag.

The bundle analytics system 512 includes an analytics report constraints generation engine 518 and an analytics report generation engine 520. In a specific implementation, the analytics report constraints generation engine 518 functions to generate analytics report constraints. Analytics report constraints can be used to generate analytics reports. The analytics report constraints generation engine 518 can generate analytics report constrains based on tag generation input received by the input receipt engine 514. Analytics report constraints can specify tags for which to create analytics reports. For example, the analytics report constraints generation engine 518 can generate analytics report constraints that specify to generate analytics report for partner tags that associate a specific partner with a product bundle.

In a specific implementation, the analytics report generation engine 520 functions to generate analytics reports. The analytics report generation engine 520 can generate an analytics report from bundle performance data stored in the bundle performance datastore 510. Additionally, the analytics report generation engine 520 can generate an analytics report from tags in product bundles included as part of bundle performance data stored in the bundle performance datastore 510. The analytics report generation engine 520 can generate an analytics report based on analytics report constraints generated by the analytics report constraints generation engine 518. For example, analytics report constraints can specify to create an analytics report for partner tags that associated a product bundle with a specific partner, and the analytics report generation engine 520 can generate an analytics report for the specific partner from the bundle performance data stored in the bundle performance datastore 510. The analytics report generation engine 520 can also generate an analytics report using analytics conditions stored in the analytics conditions datastore 506. For example, if an analytics condition specifies an amount of revenue sharing for a particular partner, then the analytics report generation engine 520 can specify an amount of revenue to share for the particular partner based on the analytics condition.

In an example of operation of the example system shown in FIG. 5, the input receipt engine receives tag generation input. Further in the example of operation, the analytics conditions generation engine 516 generates analytics conditions based on the tag generation input received by the input receipt engine 514. Still further in the example of operation, the analytics conditions are stored in the analytics conditions datastore 506. Further in the example of operation, the bundle performance data collection engine 508 collects bundle performance data for product bundles. Further in the example of operation, the bundle performance data collected by the bundle performance data collection engine 508 is stored in the bundle performance datastore 510. Still further in the example of operation, the analytics report constraints generation engine 518 generates analytics report constraints based on tag generation input received by the input receipt engine 514. Further in the example of operation, the analytics report generation engine 520 generates an analytics report using bundle performance data stored in the bundle performance datastore 510, analytics conditions stored in the analytics conditions datastore 506, and analytics report constraints generated by the analytics report constraints generation engine 518.

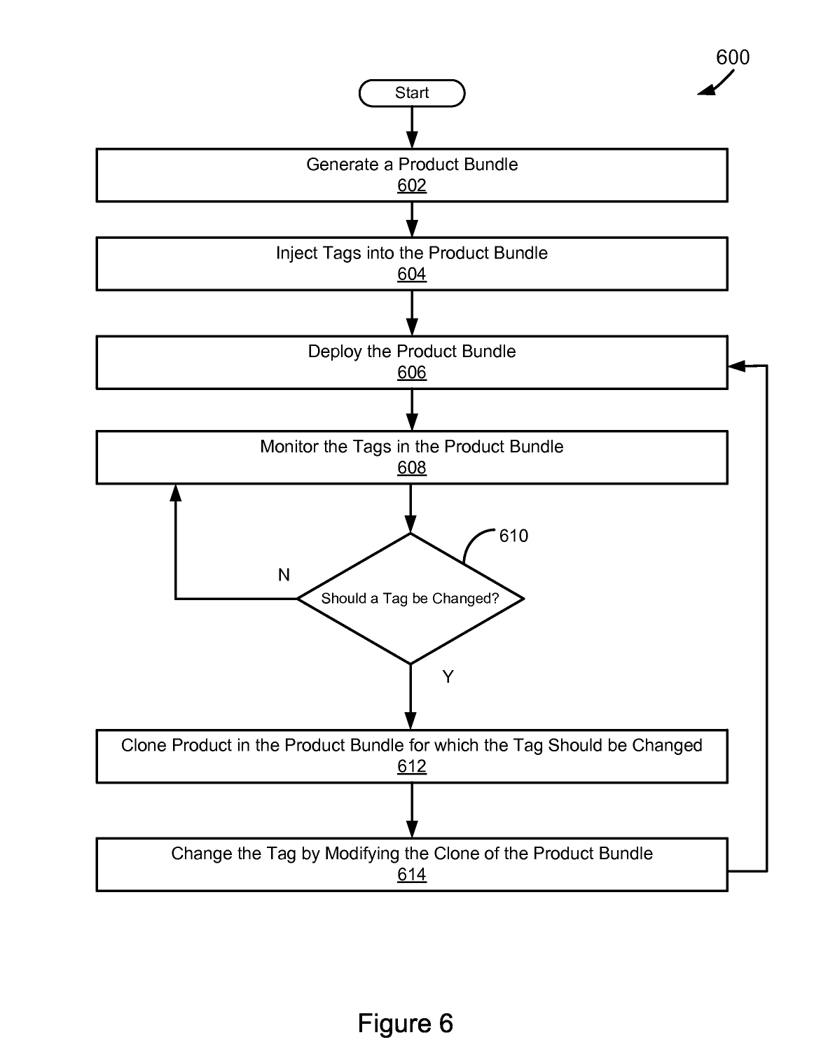

FIG. 6 depicts a flowchart 600 of an example of a method for controlling tags injected into a product bundle. The flowchart 600 begins at module 602, where a product bundle is generated. A product bundle can include primary products and advertised products. Products can include applications. A product bundle can be a dynamic product bundle that changes as a user interacts with the product bundle. Additionally, a product bundle can be a dynamic product bundle that includes dynamic primary products that change as a user interacts with the product bundle.

The flowchart 600 continues to module 604, where tags are injected into a product bundle. Tags injected into the product bundle can include immutable tags. Tags injected into the product bundle can also include mutable tags. Immutable and mutable tags injected into the product bundle can include partner tags, campaign tags, source tags, region tags, affiliate tags, and brand tags.

The flowchart 600 continues to module 606, where a product bundle, including the injected tags, is deployed. A product bundle can be deployed to a user requesting a product. A product bundle can also be deployed to an entity for display in an advertisement network. In one example, a product bundle is deployed to a partner. In another example, a product bundle is deployed to an affiliate.

The flowchart 600 continues to module 608, where tags in a product bundle are monitored. Tags can be monitored in a product bundle throughout the life of the product bundle. For example, the tags can be monitored as the product bundle is advertised in an advertisement network. Additionally, tags can be monitored as a user interacts with a product bundle. Tags can be monitored by a tag management system.

The flowchart 600 continues to decision point 610 where it is determined whether a tag in a product bundle should be changed. Whether a tag should be changed can be determined by a tag monitoring engine. Whether a tag should be changed can depend on whether a parameter that the tag associates with a product bundle has changed. For example, if a user interacting with a product bundle is in a different region than a region that is associated to products in a product bundle by a region tag, then it can be determined that the region tag should be changed. If it is determined at decision point 610 that tags in a product bundle should not be changed, then the flowchart 600 continues to module 608, where the tags in the product bundle are monitored.

If it is determined at decision point 610 that a tag should be changed, then the flowchart 600 continues to module 612. At module 612, a product bundle that includes a tag that should be changed is cloned. A product bundle can be cloned by a product bundle clone engine.

The flowchart 600 then continues to module 614, where the tag is changed in the clone of the product bundle created at module 612. A tag can be changed by changing the value of the tag. A tag can be changed in the clone of the product bundle to create a modified product bundle. A tag can be changed in a clone of a product bundle by a tag modification engine.

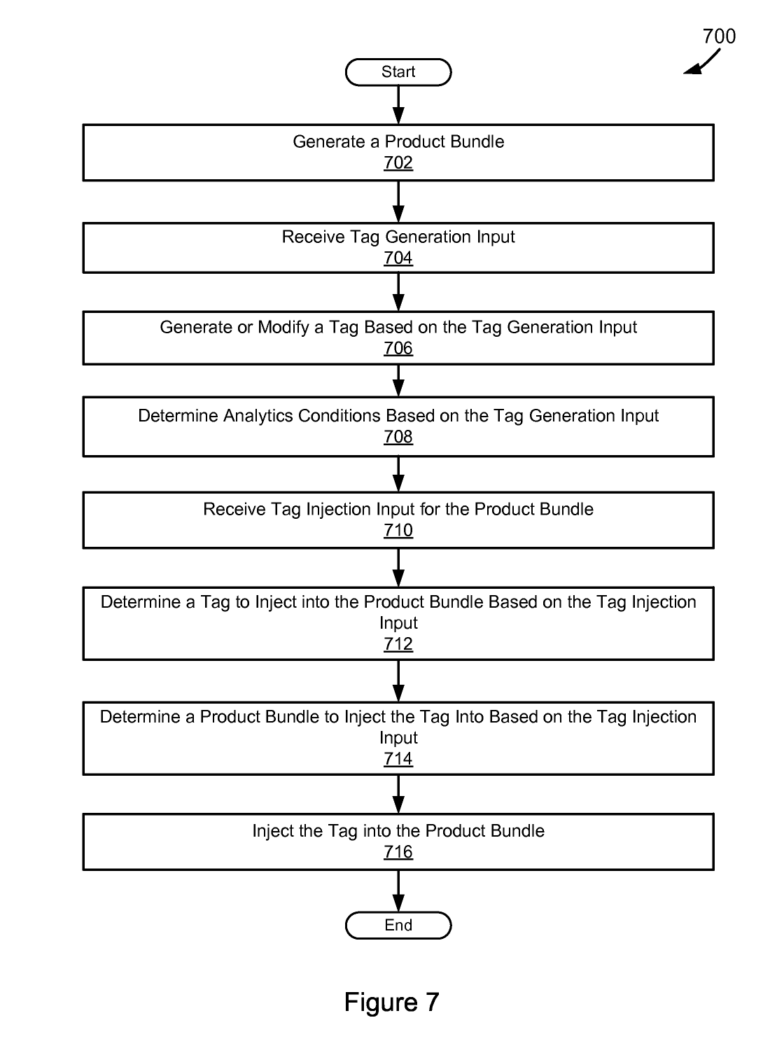

FIG. 7 depicts a flowchart 700 of an example of a method for injecting tags into a product bundle. The flowchart 700 begins at module 702, where a product bundle is generated. A product bundle can include primary products and advertised products. Products can be applications. A product bundle can be a dynamic product bundle that changes as a user interacts with the product bundle. Additionally, a product bundle can be a dynamic product bundle that includes dynamic primary products that change as a user interacts with the product bundle.

The flowchart 700 continues to module 704, where tag generation input is received. Tag generation input can be received from a developer of products included in product bundles. Additionally, tag generation input can be received from a distribution agent. Furthermore, tag generation input can be received from an entity that provides the systems for generating product bundles. Tag generation input can also be received from a partner. Further, tag generation input can be received from an affiliate. Additionally, tag generation input can be received from an advertisement network. Tag generation input can also be received from a source of network traffic, through which a user accesses a product bundle.

The flowchart 700 continues to module 706, where a tag is generated or modified based on the tag generation input received at module 704. A tag can be modified to change a value in the tag to cause the tag to associate a different parameter with a product bundle in which the tag is injected. Additionally a tag can be created to create new parameters to associate with a product bundle in which the tag is injected.

The flowchart 700 continues to module 708, where analytics conditions are determined based on the tag generation input received at module 704. Analytics conditions can be used to generate analytics reports. In one example, analytics conditions indicate revenue sharing models for various entities.

The flowchart 700 continues to module 710, where tag injection input for a product bundle is received. Tag injection input can indicate specific tags to inject into a product bundle.

The flowchart 700 continues 700 to module 712, where a specific tag to inject into a product bundle is determined based on tag injection input received at module 710. A tag determination engine can determine which specific tags to inject into a product bundle based on tag injection input.

The flowchart 700 continues to module 714, where a specific product bundle to inject a tag into is determined based on tag injection input received at module 710. A tag determination engine can determine which product bundle to inject a tag into based on tag injection input.

The flowchart 700 continues to module 716 where tag is injected into a product bundle. A tag can be injected into a product bundle by a tag injection engine. A specific tag to inject into the product bundle is determined at module 712

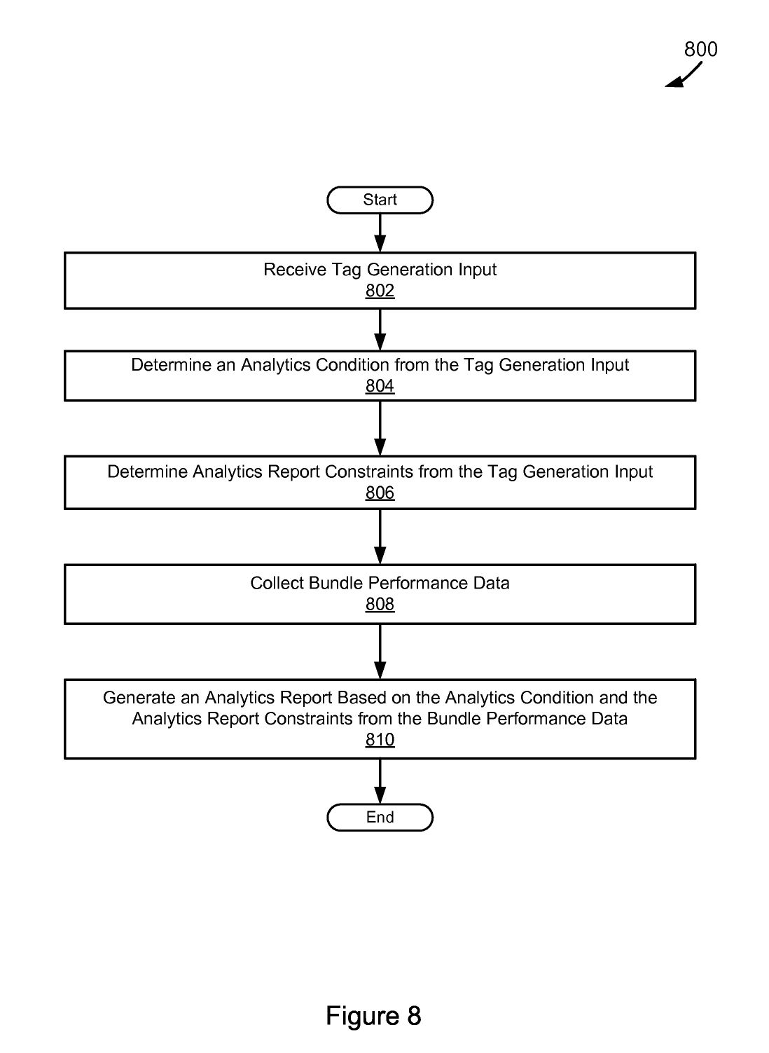

FIG. 8 depicts a flowchart 800 of an example of a method for generating an analytics report from bundle performance data that includes tags. The flowchart 800 begins at module 802 where tag generation input is received. Tag generation input can be received from a developer of products included in product bundles. Tag generation input can also be received from a distribution agent. Additionally, tag generation input can be received from an entity that provides the systems for generation product bundles. Furthermore, tag generation input can be received from a partner. Tag generation input can also be received from an affiliate. Additionally, tag generation input can be received from an advertisement network. Furthermore, tag generation input can be received from a source of network traffic, through which a user accesses a product bundle.

The flowchart 800 continues to module 804, where analytics conditions are determined from the tag generation input received at module 802. Analytics conditions can be generated from tag generation input by an analytics conditions generation engine 516. In one example, analytics conditions indicate revenue sharing models for various entities.

The flowchart 800 continues to module 806, where analytics report constraints are generated from tag generation input received at module 802. Analytics report constraints can be generated by an analytics report constraints generation engine. Analytics report constraints can include tags and/or parameters associated by tags to product bundles of which to generate analytics reports.

The flowchart 800 continues to module 808 where bundle performance data is collected. Bundle performance data can be collected by a bundle performance data collection engine. Bundle performance data can include tags in product bundles. Bundle performance data can also include mutable tags in product bundles that change during the life of the product bundle as a user interacts with the product bundle. Additionally, bundle performance data can include products in a product bundle that were downloaded or accessed by a user of the product bundle.

The flowchart 800 continues to module 810, where an analytics report is generated from bundle performance data collected at module 808 based on analytics conditions determined at module 804 and the analytics report constraints determined at module 806. An analytics report can be generated for tags or parameters identified in analytics report constraints. An analytics report can indicate the amount that a product was downloaded or accessed by users in a specific region. An analytics report can also indicate the amount of revenue an entity gained through product bundles distributed in a specific region.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
generating a product bundle;
injecting a mutable tag into the product bundle that associates the product bundle with a parameter;
deploying the product bundle;
determining whether the mutable tag should change to a new value;
if it is determined that the mutable tag should change to the new value that associates the product bundle with a new parameter:
generating a clone of the product bundle;
generating a modified product bundle by modifying the mutable tag in the clone of the product bundle to have the new value;
deploying the modified product bundle.

2. The method of claim 1, wherein the mutable tag is a campaign tag that associates a campaign parameter with the product bundle.

3. The method of claim 1, wherein the mutable tag is a source tag that associates a source parameter with the product bundle.

4. The method of claim 1, wherein the mutable tag is a region tag that associates a region parameter with the product bundle.

5. The method of claim 1, wherein the mutable tag is an affiliate tag that associates an affiliate parameter with the product bundle.

6. The method of claim 1, wherein the mutable tag is a brand tag that associates a brand parameter with the product bundle.

7. The method of claim 1, further comprising, injecting an immutable partner tag into the product bundle that associates a partner parameter with the product bundle.

8. The method of claim 1, further comprising:
collecting bundle performance data that includes tags in deployed product bundles;
receiving tag generation input;
generating analytics report constraints from the tag generation input;
generating an analytics report based on the analytics report constraints from the bundle performance data.

9. The method of claim 1, further comprising:
collecting bundle performance data that includes tags in deployed product bundles;
receiving tag generation input;
generating analytics report constraints from the tag generation input;
generating an analytics condition from the tag generation input;
generating an analytics report based on the analytics report constraints and the analytics condition from the bundle performance data.

10. The method of claim 1, wherein determining whether the mutable tag should change to the new value occurs when a distribution agent presents a link to the product bundle to a user.

11. The method of claim 1, wherein determining whether the mutable tag should change to the new value occurs once a user accesses the product bundle.

12. A system comprising:
a product bundle generation system configured to generate a product bundle;
a tag injection engine configured to inject a mutable tag into the product bundle that associates a parameter with the product bundle;
a tag monitoring engine configured to determine whether the mutable tag should change to a new value that associates the product bundle with a new parameter;
a product bundle clone engine configured to generate a clone of the product bundle if the tag monitoring engine determines that the mutable tag should change to the new value;
a tag modification engine configured to:
generate a modified product bundle by modifying the mutable tag in the clone of the product bundle to have the new value if the tag monitoring engine determines that the mutable tag should change to the new value.

13. The system of claim 12, wherein the mutable tag is a campaign tag that associates a campaign parameter with the product bundle.

14. The system of claim 12, wherein the mutable tag is a source tag that associates a source parameter with the product bundle.

15. The system of claim 12, wherein the mutable tag is a region tag that associates a region parameter with the product bundle.

16. The system of claim 12, wherein the mutable tag is an affiliate tag that associates an affiliate parameter with the product bundle.

17. The system of claim 12, wherein the mutable tag is a brand tag that associates a brand parameter with the product bundle.

18. The system of claim 12, further comprising:
a bundle performance data collection engine configured to collect bundle performance data that includes tags in deployed product bundles;
an input receipt engine configured to receive tag generation input;
an analytics report constraints generation engine configured to generate analytics report constraints from the tag generation input;
an analytics report generation engine configured to generate an analytics report based on the analytics report constraints from the bundle performance data.

19. The system of claim 12, further comprising:
a bundle performance data collection engine configured to collect bundle performance data that includes tags in deployed product bundles;
an input receipt engine configured to receive tag generation input;
an analytics report constraints generation engine configured to generate analytics report constraints from the tag generation input;
an analytics conditions generation engine configured to generate an analytics condition from the tag generation input;
an analytics report generation engine configured to generate an analytics report based on the analytics report constraints and the analytics condition from the bundle performance data.

20. A system comprising:
means for generating a product bundle;
means for injecting a mutable tag into the product bundle that associates the product bundle with a parameter;
means for deploying the product bundle;
means for determining whether the mutable tag should change to a new value that associates the product bundle with a new parameter;
if it is determined that the mutable tag should change to the new value:
means for generating a clone of the product bundle;
means for generating a modified product bundle by modifying the mutable tag in the clone of the product to have the new value;
means for deploying the modified product bundle.
